(19) United States
(12) Patent Application Publication
(10) Pub. No.: US 2023/0246910 A1
(43) Pub. Date: Aug. 3, 2023

(54) SELECTING AN ACTION TO ACHIEVE A TARGET NETWORK CONFIGURATION

(71) Applicant: Telefonaktiebolaget LM Ericsson (publ), Stockholm (SE)

(72) Inventors: Kristijonas CYRAS, San Jose, CA (US); Yifei JIN, Solna (SE); Marin ORLIC, BROMMA (SE); Jörg NIEMÖLLER, Sollentuna (SE); Leonid MOKRUSHIN, UPPSALA (SE); Aneta VULGARAKIS FELJAN, STOCKHOLM (SE)

(73) Assignee: Telefonaktiebolaget LM Ericsson (publ), Stockholm (SE)

(21) Appl. No.: 18/003,804

(22) PCT Filed: Jul. 1, 2020
(86) PCT No.: PCT/EP2020/068480

§ 371 Date: Dec. 29, 2022

(51) Int. Cl. H04L 41/0823; H04L 41/0869; H04L 41/082

(52) U.S. Cl. CPC H04L 41/0823; H04L 41/0869; H04L 41/082

(57) ABSTRACT

A method (200) performed by a node (100) in a telecommunications network for selecting a preferred action to take from a plurality of proposed actions in order to achieve a target network configuration in the telecommunications network. The method comprises obtaining (202) the plurality of proposed actions, evaluating (204) each of the plurality of proposed actions compared to the target network configuration using a computational argumentation process, and selecting (206) the preferred action, based on the results of the evaluating.

### TECHNICAL FIELD

This disclosure relates to methods, nodes and systems in a telecommunications network. More particularly but non-exclusively, the disclosure relates to selecting a preferred action to take from a plurality of proposed actions in order to achieve a target network configuration in the telecommunications network.

### BACKGROUND

Telecommunications networks are increasingly complex systems. Often, models or planners, such as models trained using machine learning processes (e.g. machine learning models, or Artificial Intelligence (AI) systems) are used to predict actions to take in a telecommunications network in order to achieve a target network configuration. Such models may compute a set of network configuration parameters or actions relevant for meeting the target network configuration. Different models may predict different actions and an action must be selected from the proposed actions to be performed.

A target network configuration can often be met in many ways that correspond to different trade-offs in various key performance indicators (KPIs). Given a target network configuration, a node such as a network management system component (e.g. which may comprise a machine learning model or agent that is responsible for optimizing/operating the system in order to achieve the goals described by the target network configuration) has to change the network parameters based on different proposals made by various models. These models may comprise independent software or AI systems, e.g. machine learning (ML) models. Their proposals may comprise network parameters that are predicted by the respective model to bring about changes to KPIs required to meet the target network configuration. The predicted improvement or deterioration of different KPIs are reasons for (pros) and against (cons) taking the proposed actions. These reasons often come with uncertainty (e.g. probabilistic confidence from ML or rule-based models) and may be conditional on other parts of the overall system configuration (e.g. operational settings). Evaluating such proposals in a transparent and explainable manner based on underlying reasons is a challenging task. Current methods for evaluating proposals are generally limited to aggregating weighted scores in KPI changes. Such aggregations of predicted KPI changes may be overly simplistic and may not facilitate efficient comparisons of the proposals from different models.

### SUMMARY

Current methods of selecting an action from proposals produced by different models may lack, among other things, the flexibility to systematically integrate non-KPI-based measures (e.g. conditional parameters pertaining to proposal actuation), they may also lack the ability to account for finer-grained sub-reasons underlying the appropriateness of a proposal (e.g. such as the historical confidence in the models providing the proposed actions). Furthermore, current methods often lack the ability to indicate to a human user more nuanced reasons behind the selection of an action, e.g. the reasons for accepting or rejecting a particular proposal.

It is thus an object of embodiments herein to provide improved methods and apparatuses for selecting a preferred action from a plurality of proposed actions in order to achieve a target network configuration in a telecommunications network.

According to a first aspect herein, there is a method performed by a node in a telecommunications network for selecting a preferred action to take from a plurality of proposed actions in order to achieve a target network configuration in the telecommunications network. The method comprises obtaining the plurality of proposed actions, evaluating each of the plurality of proposed actions compared to the target network configuration using a computational argumentation process, and selecting the preferred action, based on the results of the evaluating.

Computational argumentation processes allow for finer-grained evaluation of actions for network configuration including intent-driven evaluation and ranking of proposed actions. For example, argument-based structuring allows for the representation and evaluation of factors that are for and/or against each proposed action. Computational argumentation process often allow for flexible representation (e.g. via argument graphs) for modifying and analyzing knowledge about target network configurations, the plurality of proposed actions and the models/agents that made them. Furthermore, computational argumentation processes may provide a framework for extracting graphical, visual and textual explanations pertaining to the different proposed actions and provide reasons underlying the decision taken. In this way, selection of a preferred action may thus be better reasoned, more transparent and human readable.

According to a second aspect there is a node in a telecommunications network for selecting a preferred action to take from a plurality of proposed actions in order to achieve a target network configuration in the telecommunications network. The node comprises a memory comprising instruction data representing a set of instructions, and a processor configured to communicate with the memory and to execute the set of instructions. The set of instructions, when executed by the processor, cause the processor to: obtain the plurality of proposed actions, evaluate each of the plurality of proposed actions compared to the target network configuration using a computational argumentation process, and select the preferred action, based on the results of the evaluating.

According to a third aspect there is a computer program product comprising a computer readable medium, the computer readable medium having computer readable code embodied therein, the computer readable code being configured such that, on execution by a suitable computer or processor, the computer or processor is caused to perform the method of the first aspect.

According to a fourth aspect there is a computer program comprising instructions which, when executed on at least one processor, cause the at least one processor to perform the method of the first aspect.

According to a fifth aspect there is a carrier comprising the computer program of the first aspect, wherein the carrier is one of an electronic signal, optical signal, radio signal, or computer readable storage medium.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a node according to some embodiments herein;

FIG. 2 illustrates a method according to some embodiments herein;

FIG. 3 illustrates a system according to some embodiments herein;

FIG. 4 illustrates a signal diagram according to some embodiments herein;

FIG. 5 illustrates a visualization according to some embodiments herein; and

FIG. 6 illustrates another visualization according to some embodiments herein.

### DETAILED DESCRIPTION

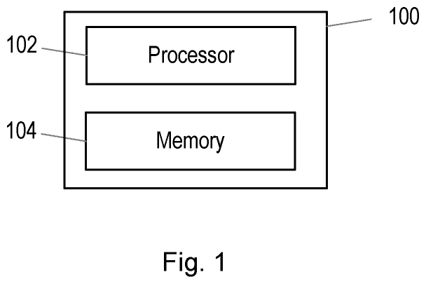

FIG. 1 illustrates a node 100 in a telecommunications network according to some embodiments herein. Generally, a telecommunications network (or communications network) may comprise any one, or any combination of: a wired link (e.g. ASDL) or a wireless link such as Global System for Mobile Communications (GSM), Wideband Code Division Multiple Access (WCDMA), Long Term Evolution (LTE), WiFi, or Bluetooth wireless technologies. The skilled person will appreciate that these are merely examples and that the telecommunications network may comprise other types of links. A wireless telecommunications network may be configured to operate according to specific standards or other types of predefined rules or procedures. Thus, particular embodiments of the telecommunications network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Generally, the node 100 may comprise any component or network function (e.g. any hardware or software module) in the communications network suitable for performing the methods described herein. For example, a node may comprise equipment capable, configured, arranged and/or operable to communicate directly or indirectly with other network nodes or equipment (e.g. such as wireless devices, or user equipments, UEs) in the communications network to enable and/or provide wireless or wired access to UEs and/or to perform other functions (e.g., resource orchestration or administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 100 may be configured or operative to perform the methods and functions described herein, such as the method 200 as described above. The node 100 may comprise a processor (e.g. processing circuitry or logic) 102. It will be appreciated that the node 100 may comprise one or more virtual machines running different software and/or processes. The node 100 may therefore comprise one or more servers, switches and/or storage devices and/or may comprise cloud computing infrastructure or infrastructure configured to perform in a distributed manner, that executes the software and/or processes.

The processor 102 may control the operation of the node 100 in the manner described herein. The processor 102 can comprise one or more processors, processing units, multi-core processors or modules that are configured or programmed to control the node 100 in the manner described herein. In particular implementations, the processor 102 can comprise a plurality of software and/or hardware modules that are each configured to perform, or are for performing, individual or multiple steps of the functionality of the node 100 as described herein.

The node 100 may comprise a memory 104. In some embodiments, the memory 104 of the node 100 can be configured to store program code or instructions that can be executed by the processor 102 of the node 100 to perform the functionality described herein. Alternatively or in addition, the memory 104 of the node 100, can be configured to store any requests, resources, information, data, signals, or similar that are described herein. The processor 102 of the node 100 may be configured to control the memory 104 of the node 100 to store any requests, resources, information, data, signals, or similar that are described herein.

The memory 104 may comprise instruction data representing a set of instructions. The processor 102 may be configured to communicate with the memory 104 to execute the set of instructions. The set of instructions, when executed by the processor, may cause the processor to perform any of the methods herein, such as the method 200 described below.

It will be appreciated that the node 100 may comprise other components in addition or alternatively to those indicated in FIG. 1. For example, in some embodiments, the node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of node 100 may be configured to control such a communications interface to transmit to and/or receive from other nodes or network functions requests, resources, information, data, signals, or similar.

Briefly, in one embodiment, the node 100 may be for selecting a preferred action to take from a plurality of proposed actions in order to achieve a target network configuration in the telecommunications network. The node 100 may be configured (e.g. adapted to): obtain the plurality of proposed actions; evaluate each of the plurality of proposed actions compared to the desired target network configuration using a computational argumentation process; and select the preferred action, based on the results of the evaluating.

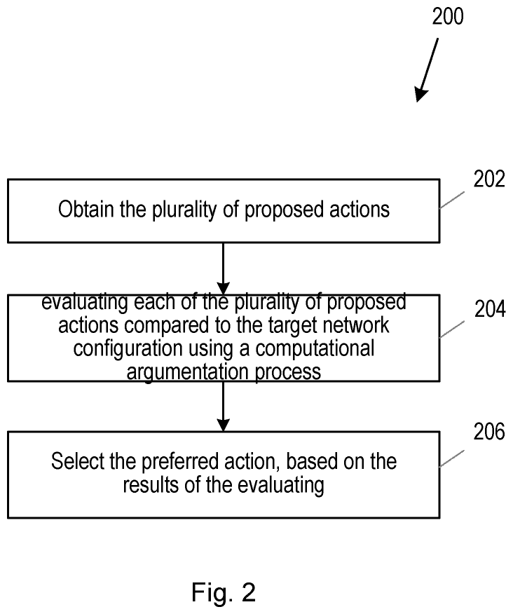

Turning now to FIG. 2 there is a method 200 performed by a node in a telecommunications network for selecting a preferred action to take from a plurality of proposed actions in order to achieve a target network configuration in the telecommunications network. In a first step 200, the method comprises obtaining 202 the plurality of proposed actions. In a second step the method 200 comprises evaluating 204 each of the plurality of proposed actions compared to the target network configuration using a computational argumentation process. In a third step the method 200 comprises selecting 206 the preferred action, based on the results of the evaluating.

Thus there is provided a method to represent and evaluate proposed actions together with their underlying reasons and other relevant information using computational argumentation. To summarize various embodiments herein, some embodiments represent information pertaining to proposed actions (such as the target network configurations addressed, the proposed actions, the reasons behind the proposed actions in terms of KPIs, the relevant information about the models themselves, the relevant system configuration parameters) in an argumentation framework, such as an argument graph with nodes (called arguments) that hold information, and edges representing relationships between them. Argumentation semantics may be used to solve the argument graph thereby determining the final strengths of all the arguments. The use of computational argumentation herein may yield better and more nuanced decisions and enables human-readable explanations thereof.

In more detail, the method 200 may be performed by a node such as the node 100 described above. The telecommunications network may comprise any of the types of telecommunications networks described.

A target network configuration or target network state may comprise a network configuration that is e.g. desired or aimed for in the telecommunications network. The target network state may comprise, for example, an optimised network state. In other embodiments, the target network state may relate to the requirements of a network use case (e.g. requirements set out in a specification such as an ultra-reliable low latency communications URLLC specification, or a service level agreement (SLA)).

In some embodiments, the target network state may be defined using key performance indicators KPIs, for example, the target network configuration may comprise (target) values of a set of KPIs. In other words, the target network configuration may be expressed in terms of a set of key performance indicators, KPIs, to be met in the telecommunications network. A target network configuration may also be described as a business intent (BI). In embodiments where the target network configuration comprises a BI, there may be a correspondence between BIs and KPIs, e.g. a pre-defined mapping, such that the BI may be defined in terms of a set of KPIs.

As used herein an action may comprise any action that may be performed, e.g. by the node 100, in order to effect a change or initiate a process in the telecommunications network. The proposed actions may comprise actions that are predicted to change the current network configuration to (or towards) the target network configuration. In some embodiments, an action may comprise a proposal to set (or change) values of network configuration parameters in the telecommunications network. Examples of actions include, but are not limited to: opening a port or setting a parameter.

As noted above, in step 202 the method comprises obtaining a plurality of proposed actions. Generally, the proposed actions may be obtained using any type of model that takes as input parameters related to the current state or configuration of the telecommunications network and outputs a proposed action that may be taken in order to achieve the target network configuration. An example of such a model is found, for example, in the paper by Asghar, Farooq & Imran 2018 entitled: “Self-Healing in Emerging Cellular Networks: Review, Challenges, and Research Directions”; IEEE Communications Surveys & Tutorials, Vol 20, No. 3, Third Quarter 2018.

Thus in some embodiments, the step of obtaining 202 the plurality of proposed actions comprises requesting a model to predict an action that will achieve the target network configuration.

In some embodiments, the proposed actions may be obtained using computational models, including but not limited to analytical (e.g. optimization, constraint programming, planning), learning-based (e.g. machine learning, ML, models), and heuristic (e.g. rule-based) models that compute a set of network configuration parameters or actions relevant for meeting the target network configuration. The skilled person will be familiar with the use of machine learning models (e.g. models trained using a machine learning process) for predicting actions to perform in order to move a network configuration from a current configuration towards a target network configuration. Machine learning models may comprise, for example, (deep) neural network models, support vector machines (SVMs), random forests etc.

As noted above, the obtained proposed actions comprise actions that, according to the respective models, may lead to changes in KPIs corresponding to the target network configuration. Other KPIs not deemed directly relevant to the given target network configuration may be affected too.

In some embodiments, the proposed actions may be arranged into a tuple of the following format:

<(a₁, . . . aₘ),(k₁, . . . kₙ),(c₁, . . . cₙ)>,

where
1. aᵢ are proposed actions to perform or parameters to set (e.g. a₁ may comprise an action such as “Open Port 10”),
2. kⱼ comprises a value of KPI x, supposedly achieved using some or all of the aᵢs (e.g. k₁=20 ms for K₁ Latency), and
3. cⱼϵ[0,1] is a score associated with kⱼ, such as the confidence in prediction kⱼ for an ML model or (a normalized, aggregated) cost of achieving kⱼ for a planner (e.g. c₁=0.95).

More generally, the step of obtaining 202 the plurality of proposed actions may further comprise obtaining, for each proposed action of the plurality of proposed actions: i) a prediction of a change in a value of a key performance indicator, KPI, that is predicted to result from the proposed action, and ii) a confidence value reflecting a confidence in the respective prediction. The confidence value or score may reflect a confidence as reported by the model that the predicted action will achieve the target network configuration.

Other information relevant to the proposed action may also be obtained in step 202, including but not limited to:

a) Current values v₁, . . . , vₙ of KPIs K₁, . . . , Kₙ (e.g. vⱼ=25 ms).
b) Other information relevant for decision making such as:
i. One or more weights wⱼϵ[0,1] indicating the importance of KPI Kⱼ.
ii. Confidence scores hⱼϵ[0,1] concerning the historical performance of (the predictions for KPIs by) the proposing model, if available. Such historical performance measures may be maintained, for example, by the operations support systems (OSS). They may be defined and calculated by recording whether implementing models' proposed actions historically has led to the predicted KPI improvements (kⱼ vs vⱼ) and/or adhered to the suggested costs (cⱼ). E.g. hⱼ=0.8 means that implementing the given model's proposed actions in the past resulted in the predicted KPI Kⱼ value vⱼ 80% of the time.
iii. Feasibility parameters comprising qualitative information pertaining to feasibility of proposed actions or actions therein, for example ¬aᵢ indicating that action aᵢ in proposed action P is impossible (e.g. Port 10 is non-functional), or ¬P[Kₛ_{₁}, . . . , Kₛ_{ₜ}] indicating that P fails to address KPIs Kₛ_{₁}, . . . , Kₛ_{ₜ} corresponding to the given target network configuration (e.g. ¬P[coverage]), or ¬P[Kₛ_{ᵢ}:dₛ_{₁}, . . . , Kₛ_{ₜ}:dₛ_{ₜ}] indicating that P fails to achieve the desired values dₛ_{₁}, . . . , dₛ_{ₜ} of KPIs Kₛ_{₁}, . . . , Kₛ_{ₜ} (e.g. ¬P[Latency: ≤22]). Such information can for instance be available to the OSS by inspection (but not visible to the proposing model) or provided by an operator based on expert knowledge.

In step 204, the method comprises evaluating each of the plurality of proposed actions compared to the target network configuration using a computational argumentation process. Computational argumentation processes will be familiar to the skilled person, but in brief, computational argumentation enables proposals to be compared by analysing pros and cons of different proposed actions, in a similar manner to the way that humans analyse competing proposals. Computational argumentation thus provides a framework for analysing proposed actions by making use of logic in order to formalize the presentation of arguments and counterarguments and deal with conflicting information. Examples of computational argumentation processes include, for example, Quantitative Bipolar Argumentation as described in the paper by P. Baroni, A. Rago, and F. Toni, entitled: “From Fine-Grained Properties to Broad Principles for Gradual Argumentation: A Principled Spectrum,” Int. J. Approx. Reason., vol. 105, pp. 252-286, February 2019 (also called Weighted Bipolar Argumentation as e.g. in the paper by L. Amgoud and J. Ben-Naim, entitled “Evaluation of Arguments in Weighted Bipolar Graphs,” Int. J. Approx. Reason., vol. 99, pp. 39-55, 2018). Other methods of computational argumentation include, for example, gradual argumentation (such as Weighted Argumentation as described e.g. in the paper by P. E. Dunne, A. Hunter, P. McBurney, S. Parsons, and M. Wooldridge, entitled “Weighted Argument Systems: Basic Definitions, Algorithms, and Complexity Results,” Artif. Intell., vol. 175, no. 2, pp. 457-486, 2011, and Quantitative/Weighted Bipolar Argumentation as above) and various forms of Abstract and Structured Argumentation (as overviewed e.g. in the book by I. Rahwan and G. R. Simari, entitled “Argumentation in Artificial Intelligence,” Springer, 2009).

In some embodiments, according to the computational argumentation method, a proposed action may be given an initial strength. The initial strength may be an arbitrary number, e.g. such as 1.0 or 0.5. All proposed actions may be given the same initial strength (e.g. each proposed action may initially be treated equally to any other proposed action). As such, a proposed action P with initial strength 0.5, may be denoted arg (P, 0.5).

In some embodiments, step 204 may comprise determining, according to the computational argumentation process, one or more arguments for the proposed action. The one or more arguments may comprise arguments in favour of the proposed action being likely to achieve the target network configuration, and/or arguments against the proposed action being likely to achieve the target network configuration.

Generally, an argument may comprise any information in favour of (e.g. supporting) or against (e.g. opposing) the proposed action. An argument may comprise, for example, a statement of mathematical logic that either supports or opposes the proposed action (e.g. supports that the proposed action will or will not achieve the target network configuration). An argument may convey semantic information, for example, either as an atomic entity or via its structure. An argument may be uniquely identifiable (e.g. via identifier or name).

Arguments may be represented using identifiers. Such identifiers can be unique strings of characters that may either stand for themselves (have semantics by convention) or be used as pointers to objects with more complex structure. In more detail, an argument may comprise an atomic entity. When constructing/determining arguments, the arguments may be defined as “Args is a set of arguments”, or, with a clarification, that “Args is a set whose elements are called arguments”. For reference, names may be given to arguments, just like to any other objects.

In practice, since in computational argumentation arguments and relationships among them are represented via graphs, primitive graph terminology may be used: arguments may be (represented via) nodes in a graph, and relationships may be (represented via) directed edges/arcs in the graph. Arguments/nodes may have names for reference, and relationships too (e.g. attack, support as described in more detail below). Arguments/nodes as well as relationships/edges can additionally carry information such as their meaning (for instance that it is a proposed action or achievable effect) or strength (for instance a number between 0 and 1). Such information can be codified in various ways, for instance by reference via argument name to some knowledge/database or even by defining argument itself as a tuple such as (name, meaning, strength, . . . ). These are information storage and processing aspects; mathematically, an argument can be a primitive object.

In embodiments where, as noted above, for each proposed action, a prediction of a change in a value of a key performance indicator, KPI, that is predicted to result from the proposed action, and a confidence value reflecting a confidence in the respective prediction is obtained, the step of determining one or more arguments may comprise determining a first argument based on the obtained prediction and the corresponding confidence values. In other words, predicted KPI changes and the confidence in said KPI changes may be used as arguments in support of, or against (detracting from) a proposed action.

In some embodiments, the first argument comprises an argument in favour of the proposed action if the obtained prediction of the change in the value of the KPI suggests that the outcome of the proposed action will change the KPI in a direction consistent with the target network configuration. Conversely, the first argument may comprise an argument against the proposed action if the obtained prediction of the change in value of the KPI suggests that the outcome of the proposed action will change the KPI in a direction inconsistent with the target network configuration.

In some embodiments, the first argument may comprise an argument against the proposed action if the KPI can be shown to be unaffected by the proposed action. For example, if other information obtained in step 202 shows that the KPI may not be changed in the manner suggested by the proposed action, then this may be used as an argument against the proposed action.

In some embodiments, where, as noted above, step 202 further comprises obtaining, for each proposed action of the plurality of proposed actions, a feasibility parameter related to a feasibility of the proposed action, the step of determining one or more arguments may comprise determining a second argument based on the feasibility parameter.

A feasibility parameter may comprise information relevant to whether it is possible to perform the proposed action, or part of the proposed action. For example, a feasibility parameter may comprise an indication of whether equipment or physical components in the telecommunications network (e.g. such as ports, or particular nodes) suitable for performing the proposed action are operational. E.g. if a physical component is unavailable to perform the proposed action, then a feasibility parameter may be used to convey this information, and/or to convey that the proposed action is unfeasible. In other examples, a feasibility parameter may indicate whether a proposed action can address (or cannot address) all KPIs in a target network configuration. For example, whether or not there is a causal relationship between the proposed action and each KPI in a target network configuration.

Generally, the second argument may comprise an argument in favour of the proposed action if the feasibility parameter indicates that the proposed action is feasible. Conversely an argument against the proposed action if the feasibility parameter indicates that the proposed action is unfeasible.

In some embodiments, obtaining the plurality of proposed actions further comprises obtaining an indication of an accuracy of the model that predicted the proposed action. The accuracy may comprise a historical accuracy of previous predictions made by the model, e.g. historically whether the model achieved the target network configuration in the manner predicted. The step of determining one or more arguments may thus comprise determining a third argument based on the indication of accuracy of the model. In some embodiments, the third argument may comprise an argument in favour of the proposed action if the indication of accuracy suggests that the model that predicted the proposed action historically has an accuracy greater than a threshold accuracy level. Conversely, the third argument may comprise an argument against the proposed action if the indication of accuracy suggests that the model that predicted the proposed action historically has an accuracy less than a threshold accuracy level. In this way, historical accuracy of a model may be taken into account when selecting a proposed action.

Turning now to more detailed examples, arguments may be given initial strengths, e.g. between 0 and 1. Initial strengths of some arguments may be determined, for example, using components such as KPI value changes. As an example, if a component (e.g. historical score) is unavailable, its value can be taken as 1. Arguments carrying other qualitative information, may be given an initial strength of 1. However this is just an example whereby the value 1 was chosen for simplicity. In principle, any argument whose initial strength is not determined by the components supplied by the Decision Maker, may be given some fixed initial strength, such as, for example, 0.5.

Using the same notation as defined above, Arguments, collectively denoted Args, may comprise arguments such as, for example:
a. Proposal P with initial strength 0.5, denoted arg (P, 0.5),
b. (weighted) KPI changes, denoted by

$$arg ( {P Δ K}_{j} , {w}_{j} \cdot \frac{\vert {k}_{j} - {v}_{j} \vert}{{v}_{j}} ) ,$$

where PΔKⱼ is the argument's name and

$${w}_{j} \cdot \frac{\vert {k}_{j} - {v}_{j} \vert}{{v}_{j}}$$

the initial strength (similar notation applies throughout),
c. (historically weighted) proposal confidence or cost, denoted by arg (PKⱼ, hⱼ·cⱼ),
d. Other qualitative pertinent information, such as
   i. Infeasible actions, denoted by arg(¬aᵢ, 1),
   ii. Non-achieved KPIs, denoted by arg (¬P[Kₛ:dₛ],1).
      Attack and support relationships may be made between arguments. For example, a support relationship may be denoted supp and the notation supp(A,B) may be used to denote that argument named A supports argument named B. Arguments supporting a proposed action, P may include, for example:
i.

$$arg ( {P Δ K}_{j} , {w}_{j} \cdot \frac{\vert {k}_{j} - {v}_{j} \vert}{{v}_{j}} )$$

whenever increasing (or respectively decreasing) KPI Kⱼ is desirable and kⱼ−vⱼ≥0 (respectively kⱼ−vⱼ<0), where the support relationship is denoted by supp(PΔKⱼ,P).
ii. Arguments supporting PΔKⱼ include arg(PKⱼ,hⱼ·cⱼ), denoted supp(PKⱼ,PΔKⱼ), possibly only when hⱼ is above a pre-specified threshold value Hⱼ, i.e. if hⱼ≥Hⱼ. (Such Hⱼ can be for instance specified by a human expert.)

An attack relationship may be denoted att and att(A,B) may be used to denote that argument named A attacks (is against) an argument named B.
Arguments attacking P include:
   a) arg(P¬aᵢ,1), denoted att(P¬aᵢ,P) (similar notation applies but is omitted henceforth),
   b) arg (¬P[Kₛ], 1) whenever s∉{1, . . . , m}, i.e. Kₛ is not among the KPIs affected by P, and
   c)

$$arg ( {P Δ K}_{j} , {w}_{j} \cdot \frac{\vert {k}_{j} - {v}_{j} \vert}{{v}_{j}} )$$

whenever increasing (resp. decreasing) KPI Kⱼ is desirable and kⱼ−vⱼ<0 (resp. kⱼ−vⱼ≥0).
II. Arguments attacking PΔKⱼ include
   a) arg (P¬[Kₛ:dₛ],1) whenever s∈{1, . . . , m}, increasing (resp. decreasing) Kₛ is desired and kₛ<vₛ (resp. kₛ≥vₛ), i.e. Kₛ is among the KPIs affected by P but P fails to achieve the required (minimal or maximal) value d_s of K_s,
   b) possibly arg(PKⱼ, hⱼ·cⱼ) when hⱼ<Hⱼ.

Generally, the one or more arguments may be hierarchically linked. For example, such that the one or more arguments comprise a first subset of the one or more arguments that directly support the proposed action, and a second subset of the one or more arguments that support the first subset of the one or more arguments. The one or more arguments may further comprise a third subset of the one or more arguments that directly oppose the proposed action, and a fourth subset of the one or more arguments that support the opposition of the proposed action by the third subset of the one or more arguments. In other words, arguments may be made in support or against the proposed action, or in support or against other arguments (that may themselves be in support of or against the proposed action).

Examples of arguments that are hierarchically linked include, for example, arg(P) and arg(PΔK) whereby arg(P) comprises an argument that directly supports or attacks the proposed action P and arg(PΔK) comprises an argument that supports a KPI change predicted to result from the proposed action P. An argument in support of the proposed action may comprise the fact that the proposed action is predicted to change a KPI in a direction consistent with the target network configuration. A supporting argument in the hierarchy may comprise an argument in support of the fact that the KPI actually will change in the manner predicted.

Once the arguments are determined, they may be combined to determine an overall strength of the proposed action.

For example, the method 200 may comprise determining a weighting representing a strength of each of the one or more arguments for each proposed action. For example, different strengths may be attributed to each argument reflecting the relative strength or priority of each argument. In other words, how supportive or opposing the argument is to the proposed action and/or thus how much weight should be attached to each argument when determining which proposed action to select.

In some embodiments, the step of evaluating 204 each of the plurality of proposed actions compared to the target network configuration using a computational argumentation process may further comprise: combining the strengths of each of the one or more arguments for each proposed action, to determine an overall strength for the respective proposed action. The method may then comprise selecting the preferred action, based on the overall strengths of the proposed actions.

The strengths of arguments may be combined or updated based on the strengths of the arguments “below” them in the hierarchy of arguments (e.g. attacking and supporting arguments). Different formulas may be used for such updates. Thus while the arguments “at the bottom” of the hierarchy (e.g. arguments that don't have incoming attacks/supports) will normally keep their initial strengths, the strengths of all other arguments, especially those for proposed actions, may be updated based on the strengths of arguments below them in the hierarchy. Thus updating is performed to determine the overall strength of the arguments supporting/detracting from the proposed action.

The overall strength of a proposed action may be determined using quantitative bipolar argumentation semantics (e.g. formulas or algorithms) to evaluate the final strength of arguments based on their initial strengths and relationships with other arguments (i.e. support and attack). The paper by P. Baroni, A. Rago, and F. Toni 2019 as referenced above provides various example semantics or formulae for combining arguments. As an example, the overall strength σ(A) of an argument A can be calculated using the following formula:

$$σ ( A ) = \frac{1}{2} ( {max}_{supp ( B , A )} σ ( B ) - {max}_{att ( B , A )} σ ( B ) )$$

Different semantics have different properties, for instance some are more sensitive to the number of attackers/supporters, others to their strengths instead.

In some embodiments, several semantics may be determined and combined in a parametrized way depending on the properties that are desired (e.g. as set by a designer of the system). This may allow for a much more flexible approach to evaluating model proposals, than for instance the current fixed approach of aggregating weighted KPI changes in an OSS.

Turning back to FIG. 2, as noted above, in a third step, the method comprises selecting (206) the preferred action, based on the results of the evaluating. For example, a proposed action having the highest overall strength (e.g. indicating that it is the most likely of the proposed actions to achieve the target network configuration) may be selected.

In some embodiments, the method 200 may further comprise performing the preferred action, e.g. to achieve the target network configuration.

The method may further comprise generating a textual or visual representation of the computational argumentation process used to select the preferred action. For example, the visual representation may comprise a quantitative bipolar argumentation graph (QBAG).

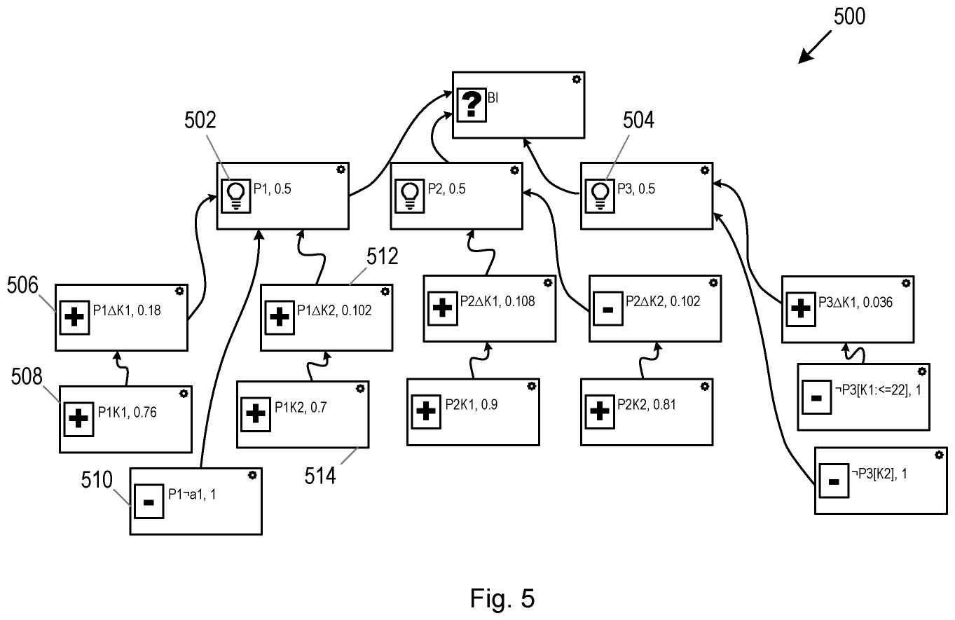

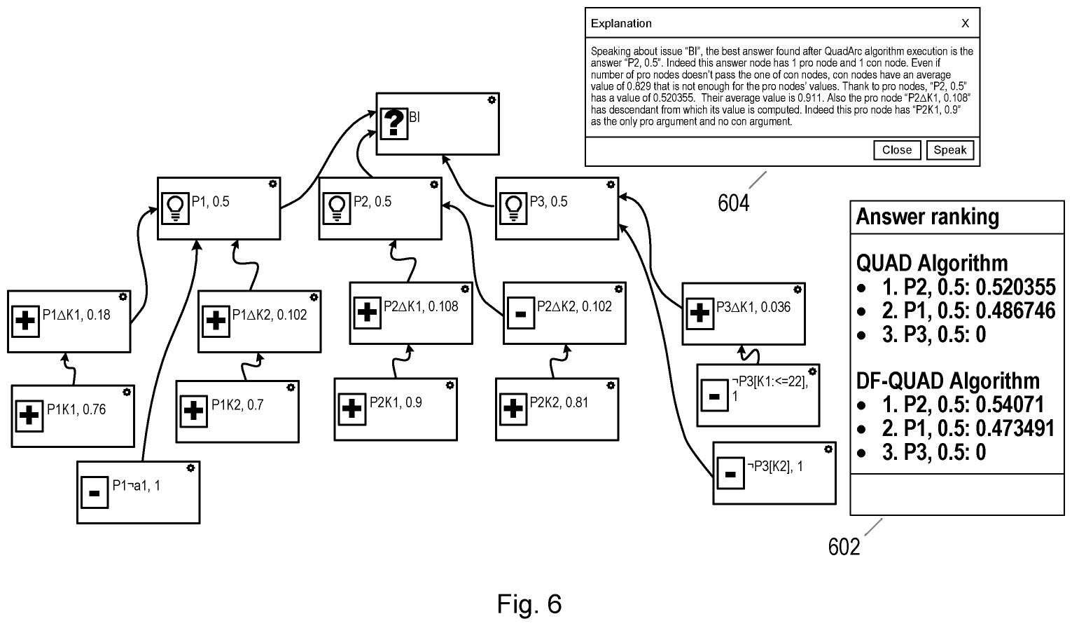

In embodiments where the arguments are hierarchically linked, for example, a visual representation may comprise or indicate the one or more arguments. The one or more arguments may be arranged in the visual representation so as to indicate the first subset of the one or more arguments, the second subset of the one or more arguments, and a manner in which the first subset of the one or more arguments and the second subset of the one or more arguments are hierarchically linked. Similarly, the visual representation may indicate the third subset of the one or more arguments, the fourth subset of the one or more arguments, and a manner in which the third subset of the one or more arguments and the fourth subset of the one or more arguments are hierarchically linked. This is illustrated and described in more detail below with respect to FIGS. 5 and 6.

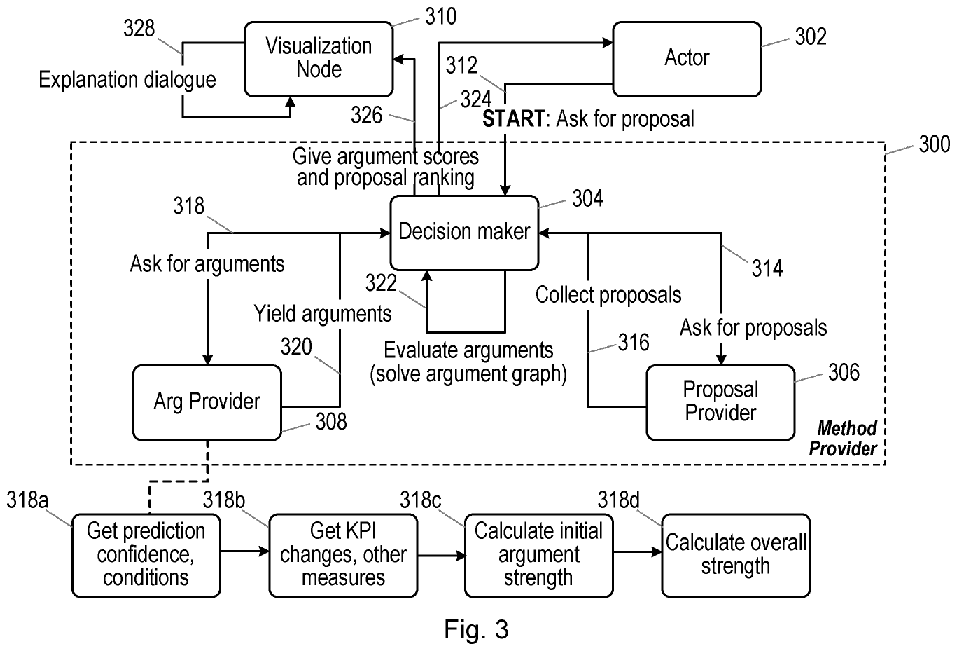

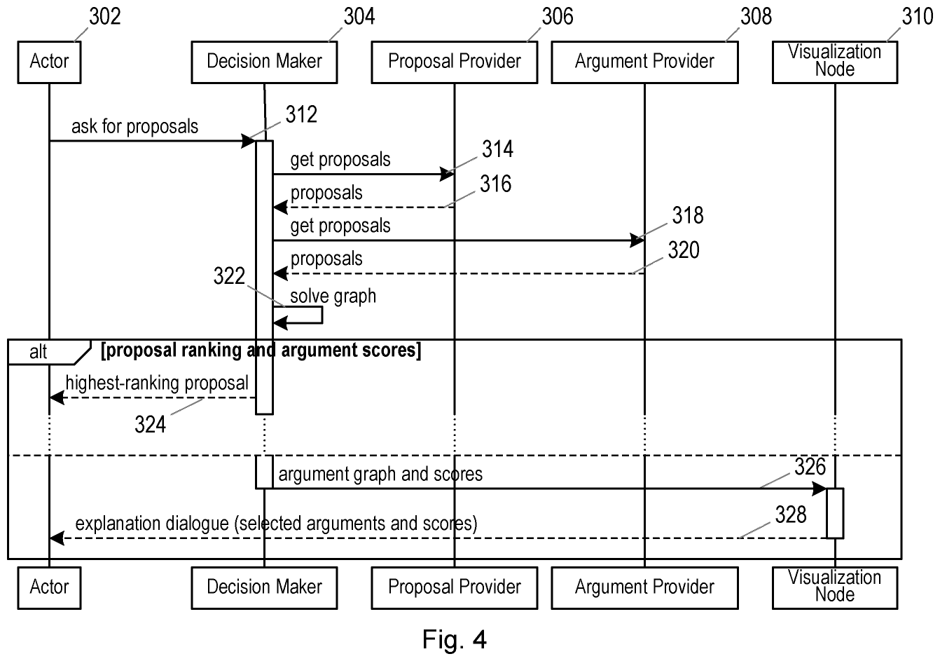

Turning now to FIGS. 3 and 4, FIG. 3 illustrates an example embodiment of a system 300 for selecting a preferred action to take from a plurality of proposed actions in order to achieve a target network configuration in the telecommunications network. In this embodiment, different steps of the method 200 are performed by different modules of the system 300. FIG. 4 illustrates the signalling performed by the different modules in the embodiment illustrated in FIG. 3.

At a high-level, the method is embodied in three modules (e.g. logical nodes), namely a Proposal Provider 306, an Arg(ument) Provider 308 and Decision Maker 304. There is also an Actor (or user) 302 who initiates the method 200 by requesting 312 an action in order to meet a target network configuration. This initiates the following steps:

314: Decision Maker 304 asks Proposal Provider 306 for proposed actions (or “proposals”).
316: Proposal Provider 306 obtains a plurality of proposed actions from external models (e.g. agents). In other words, the proposal provider performs step 202 of the method 200 as described above. The proposal provider provides the proposed actions to the Decision Maker 304.
318: The Decision Maker 304 performs step 204 of the method 200 above. Decision Maker 304 thus asks Arg Provider 308 for arguments pertaining to the proposed actions. Arg Provider 308 then a) generates arguments based on a given target network configuration, using KPI and other measures of proposals and the models, b) determines relationships between arguments, and c) calculates initial strengths and/or contribution weights of arguments and relationships as described above with respect to the method 200.
320: Arg provider 308 sends an argumentation framework (argument graph) to Decision Maker 304.
322. Decision Maker 304 then evaluates the arguments.
324. Decision maker 304 sends the argument acceptability/final strengths together with ranking for each proposed action to the Actor 302. The Actor 302 then selects a preferred action based on the results of the evaluation made by the Decision Maker (e.g. the Actor performs step 206 of the method 200 above) and performs the preferred action.
326. The decision maker may also send the argument scores and rankings to a visualization node 310 that may be used to visualize and present the argumentation and/or accompanying explanations to a human user. The visualization node 310 may produce a visualization, e.g. a graphical or textual representation for a human user. This may include explanation dialogue 328 as described below with respect to FIGS. 5 and 6.

In more detail, the Proposal Provider 306 may comprise a logical node (within e.g. a Cognitive OSS) that collects proposed actions from active proposing models and sends them to the Decision Maker 304. The Proposal Provider may collect proposed actions from the proposing models (and, for example, arrange them a tuple form as described above) to be provided to the Decision Maker 304 upon request.

In this embodiment, Quantitative bipolar argumentation is used to perform step 204, e.g. to evaluate (204) each of the plurality of proposed actions compared to the target network configuration. This is performed by the Decision Maker 304 and Arg Provider 308 in steps 318 to 322, for intent-driven argument graph construction and evaluation.

The Arg(ument) Provider may also comprise a logical node (within e.g. a Cognitive OSS). The Argument provider may provide the arguments based on information received from the Decision Maker in the proposals collected from Proposal Provider such as the prediction confidence 318a. The Argument provider 308 may also obtain KPI changes as well as the current values of KPIs 318b (those relevant for the given target network configuration) and potentially other relevant information regarding the proposed actions. The argument provider may then construct 318c weighted arguments for and against each of the proposed actions together with relationships among them, and calculate an overall strength of the proposed action 318d.

Visualization of the reasons underlying the selected or preferred action is an added benefit of using quantitative bipolar argumentation. At a high-level, the reasoning for selecting a proposed action can be traced via arguments supporting the proposal, and the reasons for and against can be contrasted with the reasons for and against other proposals, which can then for instance be parsed into text as an explanation. The Visualization node 310 in FIGS. 3 and 4 above may be tailored specifically to intent-driven decision making about proposed actions, reflecting the Arg Provider's instantiation of QBAGs with KPIs and related measures and the Decision Maker's use of semantics and properties. For example,
a sub-graph of the QBAG concerning only the highest-ranking proposal and arguments in relationship to it may be shown, alongside textual information unpacking the pros and cons of KPI changes and confidence in those.
upon request (e.g. following a user input), the second-ranked proposal may be indicated, alongside contrasting (confidence and) changes in the KPIs affected also by the highest-ranking proposal, as well as other strong arguments against the second-ranked proposal
if available, proposal strengths under other semantics can be computed for contrast, referring to the different properties satisfied.
   These aspects can also be presented for inspection in natural language, using for instance templates.

FIG. 5 shows an example simplified visualization of a QBAG (quantitative bipolar argumentation graph) according to some embodiments herein. Nodes hold arguments (rectangles comprising lightbulbs 502 (proposed actions), plus signs e.g. 506,508 (supporting arguments) and − signs e.g. 514 (attacking arguments)) and edges represent relationships (a directed edge, visualized as an arrow, from argument denoted with +/− means support/attack respectively). Argument name, e.g. P1, is followed by its initial strength, e.g. 0.5, separated by a comma (i.e. P1, 0.5). Argument names, initial strengths and support and attack relationships are determined. (There is an additional non-functional issue node named target network configuration, indicating that the three proposals are for the given target network configuration.)

In this embodiment, it is assumed that KPIs Latency, K₂: Coverage with current values v₁=25 ms, v₂=98%, required values d₁≤22,d₂≥0.95 (omitting measuring units and use decimal notation) and importance weights w₁=0.9,w₂=1. Assume proposal P₁=<(a₁, a₂), (k₁=20, k₂=0.99), (c₁=0.95, c₂=0.7)> by model A, i.e. proposed actions a₁, a₂ should bring latency to 22 ms and coverage to 99% with confidence 95% and 70%, respectively, where a1 is Open Port 10. (Note that in the graphic of FIG. 5 subscript notation is inline, e.g. P₁ appears as P1.) Then argument P₁ΔK₁ has initial strength w₁. |k₁−v₁|/v₁=0.18 and supports P₁ because decreasing Latency is desirable and k₁−v₁=−5<0. Assuming historical confidence h₁=0.8 in model's A predictions and threshold H₁ with respect to K₁ (wrt K₂, say h₂=1 by default and H₂ is void) argument P₁K₁ has initial strength h₁·c₁=0.76 and supports P₁ΔK₁, because h₁>H₁. Assuming also the knowledge that Port 10 has failed, argument P₁¬a₁ (with initial strength 1) attacks P₁. The other arguments, initial strengths and relationships are similarly determined, assuming proposals P₂=<a₃, (k₁=22, k₂=0.97), (c₁=1, c₂=0.9)> by model B with historical confidence h₁=h₂=0.9 and P₃=<a₄, k₁=24, c₁=1> by model c. (Note that P₃ results in arguments ¬P₃[K₂] and ¬P₃ [K₁: ≤22] due to its failing to address Coverage and achieve required Latency: ≤22 ms.)

FIG. 6 shows an Argument graph evaluation 602 that can be used to rank the proposed actions P1, P2 and P3. In this example, two particular examples of argumentation semantics, namely QUAD and DF-QUAD algorithms, are used to evaluate the arguments based on their initial strengths and the strengths of the related arguments. Specifically, the QUAD Algorithm (details of which can be found in e.g. P. Baroni, A. Rago, and F. Toni, 2019 as referenced above) computes the final strengths of proposal arguments using their initial strengths as well as those of the supporting and attacking arguments, (i) starting from the leaves (the arguments with no incoming edges) of the graph (which is a tree in this case), whose final strengths will be equal to their initial ones, and (ii) propagating along the edges by increasing/decreasing the strength of the supported/attacked argument in proportion to the strengths of its supporters/attackers. The final strengths of all the arguments are thus computed, but for simplicity the answer ranking given lists only those of the proposals. For instance, the final strength of P₂ is 0.520355 and that of P₁ is 0.486746, indicating that P₂ is preferred. Since P₃ has final strength 0, in this case P₂ will be chosen as the top-ranking proposal to actuate. The DF-QUAD Algorithm (also detailed in Ref. 1) works similarly, but uses slightly different formulas for determining argument strength, thus satisfying different properties and yielding somewhat different results (even though the relative ranking of proposals in this case is the same as for QUAD).

FIG. 6 further illustrates the possibility for explanations 604 using argument graphs: the structure of the graph and the nature of the evaluation algorithm allows to extract explanations 604 (e.g. in natural language) for the final argument strength in terms of the related arguments and their strengths. The above is but an example of how explanations could be extracted from QBAGs using templates (templated natural language texts instantiated with appropriate values). Explanations may be generated using tools such as, for example, Argue & Decide.

Thus, embodiments herein may use quantitative bipolar argumentation to evaluate model proposals for achieving a target network configuration. This specifically allows for automated intent-driven, fine-grained ranking of proposals based on their feasibility and capacity to address KPIs, as well as on model confidence and performance. Generally, computational argumentation representation and reasoning about proposals are informative, flexible and explainable. The disclosed method thus provides a flexible framework for the following:
collecting and relating intent-driven information pertaining to model proposals for network configuration, including both KPI-based and non-KPI-based measures.
assessing the strengths of proposed actions using both qualitative and quantitative means (enabled by quantitative bipolar argumentation) thus taking into account fine-grained numerical and logical information (provided by models, OSS or human experts indifferently).
For human operators, this allows for inspection, approval and potential modification of the evaluation process (enabled by quantitative bipolar argumentation semantics parametrized on properties, and the possibility for the user/actor to manually add/modify arguments for and against proposals as well as by the visualization and explanations via QBAGs). Thus computational argumentation is well-fitting for the purposes of representation and evaluation of intent-driven arguments in addressing target network configurations.

Turning now to other embodiments there is a computer program product comprising a computer readable medium, the computer readable medium having computer readable code embodied therein, the computer readable code being configured such that, on execution by a suitable computer or processor, the computer or processor is caused to perform any of the methods, or any of the steps of the methods described herein.

There is also a computer program comprising instructions which, when executed on at least one processor, cause the at least one processor to perform any of the methods, or any of the steps of the methods described herein.

There is also a carrier comprising a computer program such as that described above. The carrier may comprise one of an electronic signal, optical signal, radio signal, or computer readable storage medium.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method performed by a node in a telecommunications network for selecting a preferred action to take from a plurality of proposed actions in order to achieve a target network configuration in the telecommunications network, the method comprising:
obtaining the plurality of proposed actions;
evaluating each of the plurality of proposed actions compared to the target network configuration using a computational argumentation process; and
selecting the preferred action, based on the results of the evaluating.

2. The method of claim 1, wherein the step of evaluating each of the plurality of proposed actions compared to the target network configuration using a computational argumentation process comprises, for each proposed action:
determining, according to the computational argumentation process, one or more arguments for the proposed action, wherein the one or more arguments comprise arguments in favour of the proposed action being likely to achieve the target network configuration, and/or arguments against the proposed action being likely to achieve the target network configuration.

3. The method of claim 2, wherein the step of obtaining the plurality of proposed actions further comprises obtaining, for each proposed action of the plurality of proposed actions: a prediction of a change in a value of a key performance indicator, KPI, that is predicted to result from the proposed action, and a confidence value reflecting a confidence in the respective prediction; and
wherein the step of determining one or more arguments comprises determining a first argument based on the obtained prediction and the corresponding confidence values.

4. The method of claim 3, wherein the first argument comprises:
an argument in favor of the proposed action if the obtained prediction of the change in the value of the KPI suggests that the outcome of the proposed action will change the KPI in a direction consistent with the target network configuration; or
an argument against the proposed action if the obtained prediction of the change in value of the KPI suggests that the outcome of the proposed action will change the KPI in a direction inconsistent with the target network configuration.

5. The method of claim 3, wherein the first argument comprises an argument against the proposed action if the KPI can be shown to be unaffected by the proposed action.

6. The method of claim 2, wherein the step of obtaining the plurality of proposed actions further comprises obtaining, for each proposed action of the plurality of proposed actions: a feasibility parameter related to a feasibility of the proposed action; and
wherein the step of determining one or more arguments comprises determining a second argument based on the feasibility parameter.

7. The method of claim 6, wherein the second argument comprises an argument in favor of the proposed action if the feasibility parameter indicates that the proposal is feasible; or an argument against the proposed action if the feasibility parameter indicates that the proposal is unfeasible.

8. The method of claim 1, wherein the step of obtaining the plurality of proposed actions comprises requesting a model to predict an action that will achieve the target network configuration.

9. The method of claim 2, wherein
the step of obtaining the plurality of proposed actions comprises requesting a model to predict an action that will achieve the target network configuration,
obtaining the plurality of proposed actions further comprises obtaining an indication of an accuracy of the model that predicted the proposed action, and
the step of determining one or more arguments comprises determining a third argument based on the indication of accuracy of the model.

10. The method of claim 9, wherein the third argument comprises an argument in favor of the proposed action if the indication of accuracy suggests that the model that predicted the proposed action historically has an accuracy greater than a threshold accuracy level; or an argument against the proposed action if the indication of accuracy suggests that the model that predicted the proposed action historically has an accuracy less than a threshold accuracy level.

11. The method of claim 2, wherein the one or more arguments are hierarchically linked such that the one or more arguments comprise:
a first subset of the one or more arguments that directly support the proposed action, and a second subset of the one or more arguments that support the first subset of the one or more arguments; and/or
a third subset of the one or more arguments that directly oppose the proposed action, and a fourth subset of the one or more arguments that support the opposition of the proposed action by the third subset of the one or more arguments.

12. The method of claim 11, further comprising:
generating a visual representation comprising the one or more arguments, wherein the one or more arguments are arranged in the visual representation so as to indicate the first subset of the one or more arguments, the second subset of the one or more arguments, and a manner in which the first subset of the one or more arguments and the second subset of the one or more arguments are hierarchically linked.

13. The method of claim 2, further comprising determining a weighting representing a strength of each of the one or more arguments for each proposed action.

14. The method of claim 13, wherein the step of evaluating each of the plurality of proposed actions compared to the target network configuration using a computational argumentation process further comprises:
combining the strengths of each of the one or more arguments for each proposed action, to determine an overall strength for the respective proposed action; and
selecting the preferred action, based on the overall strengths of the proposed actions.

15. The method of claim 1, wherein the computational argumentation process comprises a quantitative bipolar argumentation method.

16. The method of claim 1, wherein the target network configuration is expressed in terms of a set of key performance indicators, KPIs, to be met in the telecommunications network.

17. The method of claim 1, further comprising:
performing the preferred action.

18. A node in a telecommunications network for selecting a preferred action to take from a plurality of proposed actions in order to achieve a target network configuration in the telecommunications network, the node comprising:
a memory comprising instruction data representing a set of instructions; and
a processor configured to communicate with the memory and to execute the set of instructions, wherein the set of instructions, when executed by the processor, cause the processor to:
obtain the plurality of proposed actions;
evaluate each of the plurality of proposed actions compared to the target network configuration using a computational argumentation process; and
select the preferred action, based on the results of the evaluating.

19. (canceled)

20. A computer program product comprising a computer readable medium, the computer readable medium having computer readable code embodied therein, the computer readable code being configured such that, on execution by a suitable computer or processor, the computer or processor is caused to perform the method of claim 1.

21-22. (canceled)

23. The node of claim 18, wherein the step of evaluating each of the plurality of proposed actions compared to the target network configuration using a computational argumentation process comprises, for each proposed action:
determining, according to the computational argumentation process, one or more arguments for the proposed action, wherein the one or more arguments comprise arguments in favour of the proposed action being likely to achieve the target network configuration, and/or arguments against the proposed action being likely to achieve the target network configuration.
